(19) United States
(12) Patent Application Publication
(10) Pub. No.: US 2015/0135723 A1
(43) Pub. Date: May 21, 2015

(54) COMBUSTOR NOZZLE AND METHOD OF SUPPLYING FUEL TO A COMBUSTOR

(71) Applicants: Vladimir Vasilyevich Belyaev, Moscow (RU); Gilber Otto Kraemer, Greer, SC (US); Predrag Popovic, Simpsonville, SC (US)

(72) Inventors: Vladimir Vasilyevich Belyaev, Moscow (RU); Gilber Otto Kraemer, Greer, SC (US); Predrag Popovic, Simpsonville, SC (US)

(73) Assignee: General Electric Company, Schenectady, NY (US)

(21) Appl. No.: 14/358,134

(22) PCT Filed: Feb. 21, 2012
(86) PCT No.: PCT/RU2012/000120

§ 371 Date: May 14, 2014

(51) Int. Cl. F02C 7/22; F23R 3/28; F02C 7/04

(52) U.S. Cl. CPC F02C 7/22; F02C 7/04; F23R 3/28
USPC 60/776; 60/734

(57) ABSTRACT

A combustor nozzle includes a fuel passage that extends generally axially in the nozzle and a surface that extends radially across at least a portion of the fuel passage. A projection in the surface extends generally axially down-stream from the surface, and an indention in the surface radially surrounds the projection. An oxidant supply is in fluid communication with an oxidant passage, and the oxidant passage is radially displaced from the fuel passage and terminates at an oxidant outlet. A method of supplying a fuel to a combustor includes flowing fuel through a projection in a surface, wherein the projection extends generally axially downstream from the surface, and flowing fuel through an indention in the surface, wherein the indention radially surrounds the projection. The method further includes flowing an oxidant through an oxidant outlet that circumferentially surrounds the indention in the surface.

### FIELD OF THE INVENTION

The present invention generally involves a combustor nozzle and method for supplying fuel to a combustor.

### BACKGROUND OF THE INVENTION

Combustors are commonly used in industrial and power generation operations to ignite fuel to produce combustion gases having a high temperature and pressure. For example, gas turbines typically include one or more combustors to generate power or thrust. A typical gas turbine used to generate electrical power includes an axial compressor at the front, one or more combustors around the middle, and a turbine at the rear. Ambient air may be supplied to the compressor, and rotating blades and stationary vanes in the compressor progressively impart kinetic energy to the working fluid (air) to produce a compressed working fluid at a highly energized state. The compressed working fluid exits the compressor and flows through one or more nozzles in each combustor where the compressed working fluid mixes with fuel and ignites to generate combustion gases having a high temperature and pressure. The combustion gases expand in the turbine to produce work. For example, expansion of the combustion gases in the turbine may rotate a shaft connected to a generator to produce electricity.

In some gas turbine applications, a working fluid other than ambient air may be supplied to the compressor, resulting in compressed working fluid produced by the compressor that is oxygen deficient. For example, in oxy-fuel or stoichiometric exhaust gas recirculation (SEGR) applications, a portion of the exhaust from the turbine may be supplied as the working fluid to the compressor, and the compressed working fluid supplied to the combustor may therefore be oxygen deficient. As a result, an oxidant may be separately supplied to the combustor to directly mix with the fuel prior to combustion.

It is widely known that the thermodynamic efficiency of a gas turbine increases as the operating temperature, namely the combustion gas temperature, increases. However, if the fuel and oxidant are not evenly mixed prior to combustion, localized hot spots may form in the combustor near the nozzle exits. The localized hot spots may increase the production of nitrous oxides in the fuel rich regions, while the fuel lean regions may increase the production of carbon monoxide and unburned hydrocarbons, all of which are undesirable exhaust emissions. In addition, the fuel rich regions may increase the chance for the flame in the combustor to flash back into the nozzles and/or become attached inside the nozzles which may damage the nozzles. Although flame flash back and flame holding may occur with any fuel, they occur more readily with high reactive fuels, such as hydrogen, that have a higher burning rate and a wider flammability range. Therefore, continued improvements in the combustor nozzle designs and methods for supplying fuel to the combustor would be useful to improve combustor efficiency, reduce undesirable emissions, and/or prevent flash back and flame holding events.

### BRIEF DESCRIPTION OF THE INVENTION

Aspects and advantages of the invention are set forth below in the following description, or may be obvious from the description, or may be learned through practice of the invention.

One embodiment of the present invention is a combustor nozzle that includes a fuel passage that extends generally axially in the nozzle and a surface that extends radially across at least a portion of the fuel passage. A projection in the surface extends generally axially downstream from the surface, and an indention in the surface radially surrounds the projection. An oxidant supply is in fluid communication with an oxidant passage, and the oxidant passage is radially displaced from the fuel passage and terminates at an oxidant outlet.

Another embodiment of the present invention is a combustor nozzle that includes a center body that defines a surface. A projection in the surface extends generally axially downstream from the surface, and an indention in the surface radially surrounds the projection. A first fuel outlet extends through the projection, and a second fuel outlet extends through the indention. An oxidant supply is in fluid communication with an oxidant passage, and the oxidant passage terminates at an oxidant outlet that circumferentially surrounds the second fuel outlet.

Particular embodiments of the present invention may also include a method of supplying a fuel to a combustor. The method includes flowing fuel through a projection in a surface, wherein the projection extends generally axially downstream from the surface, and flowing fuel through an indention in the surface, wherein the indention radially surrounds the projection. The method further includes flowing an oxidant through an oxidant outlet that circumferentially surrounds the indention in the surface.

Another embodiment of the present invention is a combustor nozzle that includes an axial centerline and a center body substantially aligned with the axial centerline. A fuel supply is in fluid communication with a fuel passage through at least a first portion of the nozzle. An oxidant supply is in fluid communication with an oxidant passage through at least a second portion of the nozzle. The oxidant passage terminates at an oxidant outlet, and the fuel passage is substantially co-axial with the oxidant passage.

In a still further embodiment of the present invention, a combustor nozzle includes a center body and a fuel supply in fluid communication with a fuel passage inside the center body. A first fuel outlet extends through the center body, and a second fuel outlet extends through the center body, wherein the second fuel outlet circumferentially surrounds the first fuel outlet. An oxidant supply is in fluid communication with an oxidant passage that circumferentially surrounds at least a portion of the fuel passage, and the oxidant passage terminates at an oxidant outlet.

Embodiments of the present invention also include a method for supplying fuel to a combustor. The method includes flowing fuel through a fuel outlet and flowing an oxidant through an oxidant outlet radially displaced from the fuel outlet. The method further includes flowing a diluent through a diluent outlet radially outward of the fuel and oxidant outlets.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified side cross-section view of a combustor according to one embodiment of the present invention;

FIG. 2 is an upstream axial view of the combustor shown in FIG. 1 taken along line A-A;

FIG. 3 is perspective partial cut-away view of the nozzle shown in FIG. 2 according to one embodiment of the present invention;

FIG. 4 is a side plan view of the nozzle shown in FIG. 3; and

FIG. 5 is a side plan view of the nozzle shown in FIG. 3 according to an alternate embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention provide a combustor nozzle and a method for supplying fuel to a combustor. In particular embodiments of the present invention, the combustor nozzle may be incorporated into an oxy-fuel or stoichiometric exhaust gas recirculation (SEGR) combustor. Specifically, the nozzle may supply a fuel and an oxidant through substantially concentric or co-axial fuel and oxidant passages to a combustion chamber. In this manner, a shear layer between the lower momentum fuel and the higher momentum oxidant may enhance the mixing of the fuel and oxidant prior to combustion. A diluent may also be supplied through diluent ports radially outward of the fuel and oxidant to further enhance mixing of the fuel and oxidant prior to combustion and/or adjust the flame temperature proximate to the nozzle. In particular embodiments, swirler vanes or angled outlets in the fuel and/or oxidant passages or at the end of these passages may further enhance the mixing of the fuel and oxidant prior to combustion. Although described generally in the context of a combustor nozzle incorporated into a combustor of a gas turbine, embodiments of the present invention may be applied to any combustor and are not limited to a gas turbine combustor unless specifically recited in the claims.

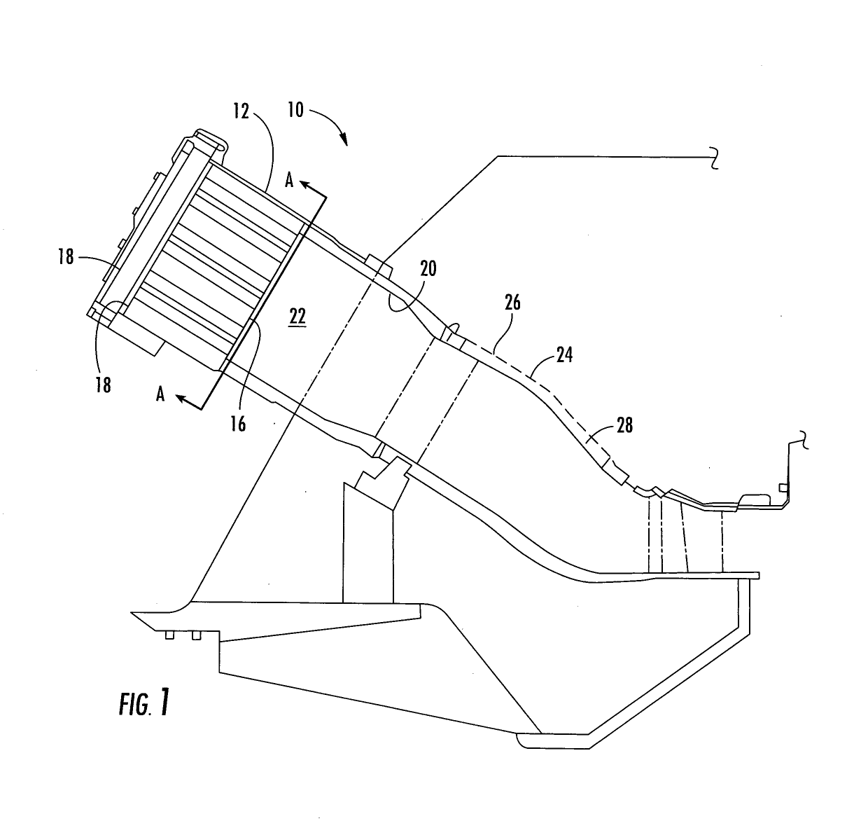

FIG. 1 shows a simplified cross-section view of an exemplary combustor 10, such as would be included in a gas turbine, according to one embodiment of the present invention. A casing 12 may surround the combustor 10 to contain the compressed working fluid flowing to the combustor 10. As shown, the combustor 10 may include one or more nozzles 14 radially arranged between a top cap 16 and an end cover 18. The top cap 16 and a liner 20 generally surround a combustion chamber 22 located downstream from the nozzles 14. As used herein, the terms “upstream” and “downstream” refer to the relative location of components in a fluid pathway. For example, component A is upstream of component B if a fluid flows from component A to component B. Conversely, component B is downstream of component A if component B receives a fluid flow from component A. A flow sleeve 24 with flow holes 26 may surround the liner 20 to define an annular passage 28 between the flow sleeve 24 and the liner 20. The compressed working fluid may pass through the flow holes 26 in the flow sleeve 24 to flow along the outside of the liner 20 to provide film or convective cooling to the liner 20. When the compressed working fluid reaches the end cover 18, the compressed working fluid reverses direction to flow through the one or more nozzles 14 where it mixes with fuel before igniting in the combustion chamber 22 to produce combustion gases having a high temperature and pressure.

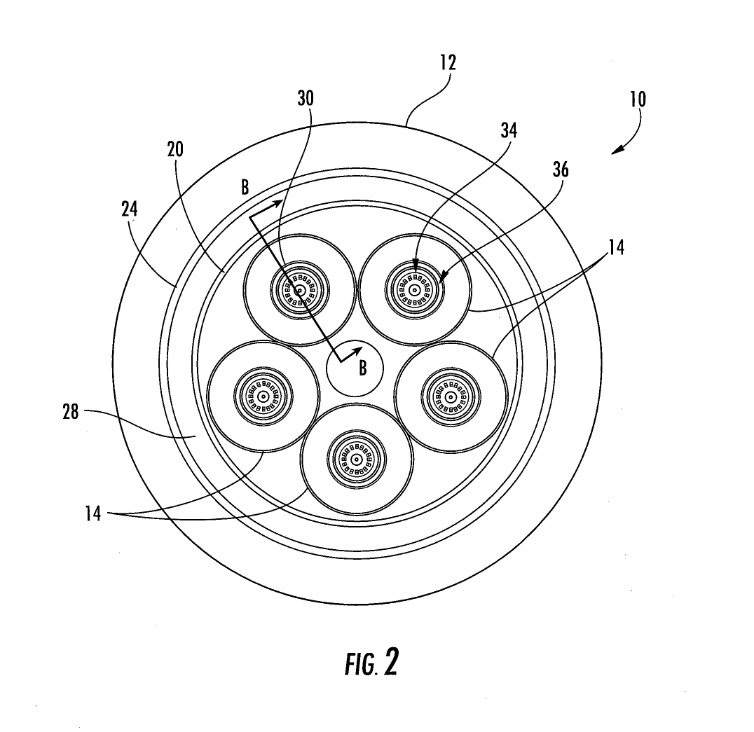

FIG. 2 provides an upstream axial view of the combustor 10 shown in FIG. 1 taken along line A-A. Various embodiments of the combustor 10 may include different numbers and arrangements of nozzles. For example, in the embodiment shown in FIG. 2, the combustor 10 includes five nozzles 14 radially arranged in the top cap 16. As previously described with respect to FIG. 1, the working fluid flows through the annular passage 28 between the flow sleeve 24 and the liner 20 (into FIG. 2) until it reaches the end cover 18 where it reverses direction to flow through the nozzles 14 (out of FIG. 2) and into the combustion chamber 22.

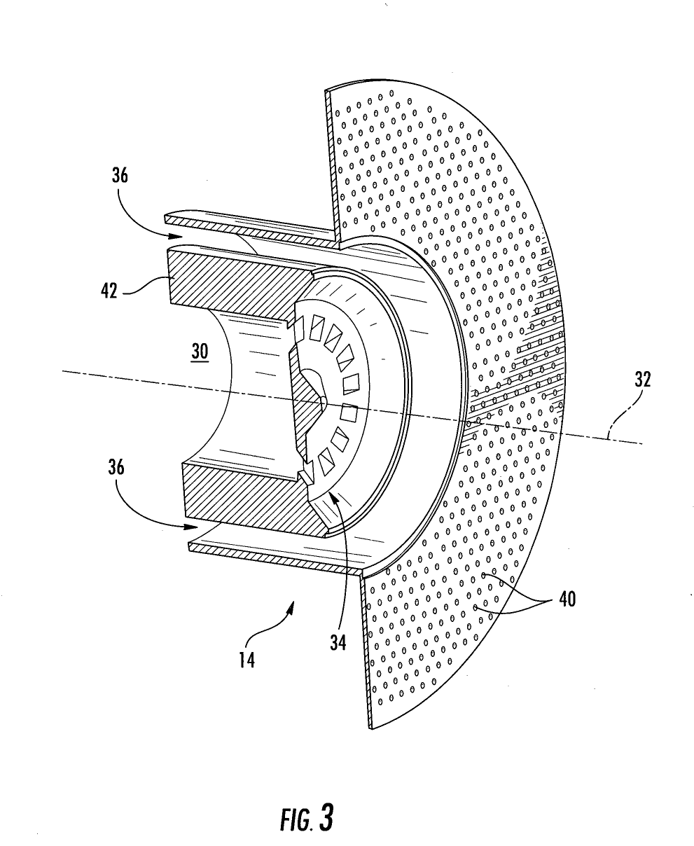

FIG. 3 provides a perspective partial cut-away view of the nozzle 14 shown in FIG. 2 according to one embodiment of the present invention. As shown, each nozzle 14 may include a plurality of substantially concentric or co-axial fluid passages that provide fluid communication through the nozzle 14 and into the combustion chamber 22. For example, a fuel passage 30 may be substantially aligned with an axial centerline 32 of the nozzle 14 and terminate at a surface 34 that extends radially across at least a portion of the fuel passage 30. Possible fuels supplied through the fuel passage 30 may include, for example, blast furnace gas, carbon monoxide, coke oven gas, natural gas, methane, vaporized liquefied natural gas (LNG), hydrogen, syngas, butane, propane, olefins, and combinations thereof. Prior to burning, the fuel may be mixed with an inert gas to control combustion reaction rates. An oxidant passage 36 may circumferentially surround at least a portion of the fuel passage 30 so that it is radially displaced from the fuel passage 30 and terminates at an oxidant outlet 38 that radially surrounds the surface 34. Oxidants supplied through the oxidant passage 36 may comprise virtually any oxygen rich fluid, such as pure oxygen (O₂) or oxygen containing compounds such as nitrogen tetroxide (N₂O₄) and hydrogen peroxide (H₂O₂). Prior to injecting into the combustion chamber 22, the oxidant may be mixed with an inert gas, for example, to increase the volumetric flow of the oxidant. A plurality of diluent apertures or diluent ports 40 may surround the fuel and oxidant passages 30, 36. Possible diluents supplied through the diluent ports 40 may include water, steam, fuel additives, various inert gases such as nitrogen and/or various non-flammable gases such as carbon dioxide or combustion exhaust gases supplied to the combustor 10 from the compressor (not shown). In this manner, the fuel and oxidant passages 30, 36 may provide fluid communication from the end cover 18, through the nozzle 14, and into the combustion chamber 22, and the plurality of diluent ports 40 radially outward of the fuel and oxidant passages 30, 36 may provide fluid communication through the nozzle 14 and into the combustion chamber 22.

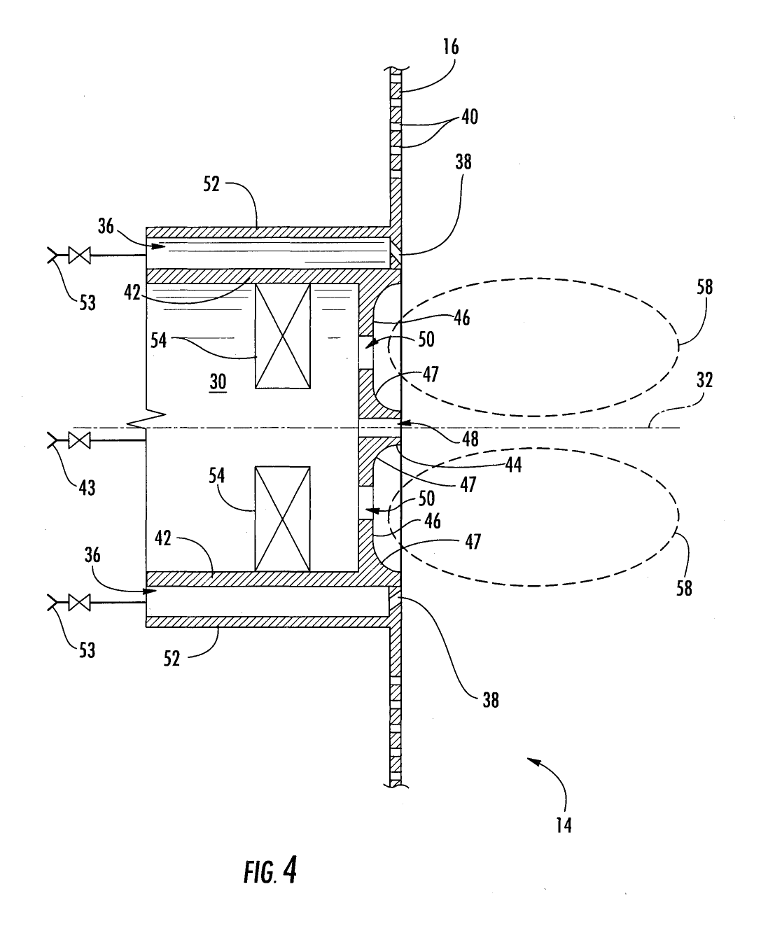

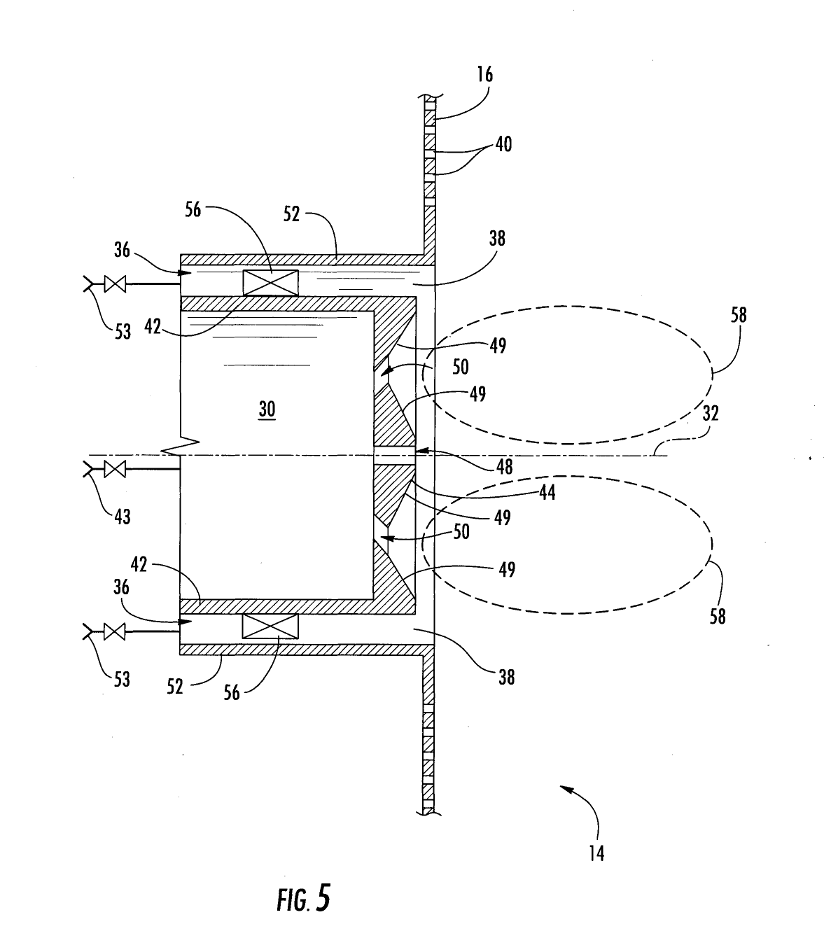

FIGS. 4 and 5 provide simplified cross-section views of the nozzle 14 shown in FIG. 2 taken along line B-B according to various embodiments of the present invention. A single or multi-piece center body 42 may be aligned with the axial centerline 32 of the nozzle 14 to define the fuel passage 30 and/or surface 34 and to provide fluid communication for a fuel supply 43 through the nozzle 14. As shown in FIG. 4, the center body 42 may axially terminate approximately even with the oxidant outlet 38 and/or diluent ports 40. Alternately, the center body 42 may axially terminate upstream from at least a portion of the oxidant outlet 38 and/or diluent ports 40, as shown in FIG. 5.

The surface 34 that extends radially across at least a portion of the fuel passage 30 may define a projection 44 and an indention 46. The projection 44 extends generally axially downstream from the surface 34 along the axial centerline 32, and the indention 46 radially surrounds the projection 44. The surface 34 between the projection 44 and the indention 46 may be a curved or arcuate surface 47, as shown in FIG. 4, or a substantially straight surface 49, as shown in FIG. 5.

The projection 44 may include a first or pilot fuel outlet 48 through the surface 34 to provide fluid communication for fuel to flow from the fuel passage 30, through the projection 44 in the surface 34, and into the combustion chamber 22. As shown in FIG. 4, the first fuel outlet 48 may be axially aligned approximately even with or co-planar with the oxidant outlet 38 and/or diluent ports 40. Alternately, the first fuel outlet 48 may be axially aligned upstream from the oxidant outlet and/or diluent ports 40, as shown in FIG. 5. The indention 46 may similarly include one or more second fuel outlets 50 radially surrounding the projection 44 to provide fluid communication for fuel to flow from the fuel passage 30, through the indention 46 in the surface 34, and into the combustion chamber 22. As shown in FIGS. 3-5, the first fuel outlet 48 in the projection 44 may be circular, while the second fuel outlets 50 in the indention 46 may be rectangular, although the particular shape or orientation of the various fuel outlets 48, 50 is not a limitation of the present invention unless specifically recited in the claims.

A shroud 52 may circumferentially surround at least a portion of the center body 42 to define the oxidant passage 36 through at least a portion of the nozzle 14 between the center body 42 and the shroud 52. The oxidant passage 36 provides fluid communication for an oxidant supply 53 through the nozzle 14.

As further shown in FIGS. 4 and 5, the fuel passage 30 and/or oxidant passage 36 may include swirler vanes or angled outlets to impart swirl to the fluid flowing through the respective passages. For example, as shown in FIG. 4, the oxidant outlet 38 may be angled between approximately 20-80 degrees with respect to the axial centerline 32 and/or may swirl clockwise or counterclockwise to impart swirl/recirculation to the oxidant exiting the nozzle 14 and entering the combustion chamber 22. Similarly, the fuel passage 30 may include one or more fuel swirler vanes 54 to impart swirl to the fuel exiting the nozzle 14 through the second fuel outlets 50 in the indention 46 aligned with the axial centerline 32. Alternately, as shown in FIG. 5, the oxidant passage 36 and/or oxidant outlet 38 may include one or more oxidant swirler vanes 56 to impart swirl to the oxidant exiting the nozzle 14 and entering the combustion chamber 22, and the second fuel outlets 50 in the indention 46 may be angled with respect to the axial centerline 32 to impart swirl/recirculation to the fuel exiting the nozzle 14 and entering the combustion chamber 22. In particular embodiments, the second fuel outlets 50 in the indention 46 may be radially separated from the axial centerline 32 by approximately 20-80 percent of the radius of the fuel passage 30 and angled between approximately 20-80 degrees with respect to the axial centerline 32.

The various embodiments of the nozzle 14 shown in FIGS. 4 and 5 thus supply fuel, oxidant, and diluent to the combustion chamber 22 to enhance one or more operating parameters of the combustor 10. Specifically, the location of the fuel and oxidant outlets 50, 48, 38 and the relative swirl between the fuel and oxidant creates a shear layer between the fuel and oxidant to enhance the mixing of the fuel and oxidant prior to combustion. The momentum of the fuel and/or oxidant may be further adjusted so lower momentum fuel having approximately 20-50 percent of the oxidant momentum may further enhance the shear layer mixing. In addition, injection of the diluent through the diluent ports 40 radially outward of the fuel and oxidant outlets 50, 38 may be used to adjust the reaction rate and flame temperature in the combustion chamber 22. Lastly, computational fluid dynamics models indicate that the fuel injected angularly with respect to the axial centerline 32 through the second fuel outlets 50 in the indention 46 produces one or more stable recirculation regions 58 downstream from the surface 34 of the nozzle 14 to promote flame stability and increase the overall efficiency of the combustor 10, and the fuel injected through the first fuel outlet 48 in the projection 44 reduces peak flame temperature.

Although the embodiments shown in FIGS. 2-5 illustrate the fuel passage 30 axially aligned with the axial centerline 32 of the nozzle 14 and the oxidant passage 36 surrounding or extending axially around the fuel passage 30, the relative locations of the fuel and oxidant passages 30, 36 is not a limitation of the present invention unless specifically recited in the claims. For example, one of ordinary skill in the art can readily appreciate that in alternate embodiments the oxidant passage 36 may be axially aligned with the axial centerline 32 of the nozzle 14 with the fuel passage 30 surrounding or extending axially around the oxidant passage 36, and further illustration of alternate arrangements is not necessary.

The various embodiments described and illustrated with respect to FIGS. 1-5 may further provide a method for supplying fuel to the combustor 10. The method may include flowing the fuel through one or more fuel outlets 48, 50 and flowing the oxidant through the oxidant outlet 38 radially displaced from the one or more fuel outlets 48, 50. The method may further include flowing the diluent through the diluent ports 40 radially outward of the fuel and oxidant outlets 48, 50, 38. In particular embodiments, the method may further include swirling at least one of the fuel or oxidant and/or flowing the fuel or oxidant through the respective fuel or oxidant outlets 48, 50, 38 at an angle between approximately 20-80 degrees with respect to the axial centerline 32 of the nozzle 14. The method may further include adjusting the fuel and/or oxidant flow rate so that the fuel has approximately 20-50 percent of momentum of the oxidant to further enhance the shear layer mixing between the fuel and the oxidant.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A combustor nozzle comprising:
a. a fuel passage extending generally axially in the nozzle;
b. a surface that extends radially across at least a portion of the fuel passage;
c. a projection in the surface that extends generally axially downstream from the surface;
d. an indention in the surface radially surrounding the projection; and
e. an oxidant supply in fluid communication with an oxidant passage, wherein the oxidant passage is radially displaced from the fuel passage and terminates at an oxidant outlet.

2. The combustor nozzle as in claim 1, further comprising a plurality of diluent ports radially outward of the fuel and oxidant passages.

3. The combustor nozzle as in claim 1, further comprising a plurality of fuel swirler vanes in the fuel passage.

4. The combustor nozzle as in claim 1, further comprising a first fuel outlet through the projection in the surface.

5. The combustor nozzle as in claim 4, wherein the first fuel outlet terminates axially upstream from the oxidant outlet.

6. The combustor nozzle as in claim 1, further comprising a plurality of second fuel outlets through the indention radially surrounding the projection.

7. The combustor nozzle as in claim 6, wherein the plurality of second fuel outlets are angled between approximately 20-80 degrees with respect to an axial centerline of the nozzle.

8. The combustor nozzle as in claim 1, wherein the oxidant outlet is angled between approximately 20-80 degrees with respect to an axial centerline of the nozzle.

9. The combustor as in claim 1, further comprising a plurality of oxidant swirler vanes in the oxidant passage.

10. The combustor nozzle as in claim 1, further comprising an arcuate surface between the projection and the indention.

11. A combustor nozzle comprising:
a. a center body, wherein the center body defines a surface;
b. a projection in the surface that extends generally axially downstream from the surface;
c. an indention in the surface radially surrounding the projection;
d. a first fuel outlet extending through the projection;
e. a second fuel outlet extending through the indention; and
f. an oxidant supply in fluid communication with an oxidant passage, wherein the oxidant passage terminates at an oxidant outlet that circumferentially surrounds the second fuel outlet.

12. The combustor nozzle as in claim 11, wherein the center body axially terminates approximately even with the oxidant outlet.

13. The combustor nozzle as in claim 11, further comprising a plurality of diluent ports radially outward of the oxidant outlet.

14. The combustor nozzle as in claim 11, wherein at least one of the first or second fuel outlets is axially aligned upstream from the oxidant outlet.

15. The combustor nozzle as in claim 11, wherein the first fuel outlet is axially aligned approximately even with the oxidant outlet.

16. The combustor nozzle as in claim 11, further comprising a plurality of second fuel outlets through the indention radially surrounding the projection.

17. The combustor nozzle as in claim 16, wherein the plurality of second fuel outlets are angled between approximately 20-80 degrees with respect to an axial centerline of the nozzle.

18. The combustor nozzle as in claim 11, wherein the oxidant outlet is angled between approximately 20-80 degrees with respect to an axial centerline of the nozzle.

19. A method for supplying fuel to a combustor comprising:
a. flowing fuel through a projection in a surface, wherein the projection extends generally axially downstream from the surface;
b. flowing fuel through an indention in the surface, wherein the indention radially surrounds the projection; and
c. flowing an oxidant through an oxidant outlet that circumferentially surrounds the indention in the surface.

20. The method as in claim 19, further comprising flowing a diluent through a diluent outlet radially outward of the oxidant outlet.

21. A combustor nozzle comprising:
a. an axial centerline;
b. a center body substantially aligned with the axial centerline;
c. a fuel supply in fluid communication with a fuel passage through at least a first portion of the nozzle;
d. an oxidant supply in fluid communication with an oxidant passage through at least a second portion of the nozzle, wherein the oxidant passage terminates at an oxidant outlet; and
e. wherein the fuel passage is substantially co-axial with the oxidant passage.

22. The combustor nozzle as in claim 21, wherein the center body axially terminates approximately even with the oxidant outlet.

23. The combustor as in claim 21, wherein the oxidant passage circumferentially surrounds at least a portion of the fuel passage.

24. The combustor nozzle as in claim 21, further comprising a plurality of diluent ports radially outward of the fuel and oxidant passages.

25. The combustor nozzle as in claim 21, further comprising a plurality of fuel swirler vanes in the fuel passage.

26. The combustor nozzle as in claim 21, wherein the fuel passage terminates at a first fuel outlet substantially aligned with the axial centerline.

27. The combustor nozzle as in claim 26, wherein the first fuel outlet is axially aligned approximately even with the oxidant outlet.

28. The combustor nozzle as in claim 21, wherein the fuel passage terminates at a plurality of second fuel outlets radially disposed about the axial centerline.

29. The combustor nozzle as in claim 28, wherein the plurality of second fuel outlets are angled between approximately 20-80 degrees with respect to the axial centerline.

30. The combustor nozzle as in claim 21, wherein the oxidant outlet is angled between approximately 20-80 degrees with respect to the axial centerline.

31. A combustor nozzle comprising:
a. a center body;
b. a fuel supply in fluid communication with a fuel passage inside the center body;
c. a first fuel outlet extending through the center body;
d. a second fuel outlet extending through the center body, wherein the second fuel outlet circumferentially surrounds the first fuel outlet; and
e. an oxidant supply in fluid communication with an oxidant passage that circumferentially surrounds at least a portion of the fuel passage, wherein the oxidant passage terminates at an oxidant outlet.

32. The combustor nozzle as in claim 31, wherein the center body axially terminates approximately even with the oxidant outlet.

33. The combustor as in claim 31, further comprising a plurality of diluent ports radially outward of the fuel and oxidant passages.

34. The combustor nozzle as in claim 31, further comprising a plurality of fuel swirler vanes in the fuel passage.

35. The combustor nozzle as in claim 31, wherein the first fuel outlet is axially aligned approximately even with the oxidant outlet.

36. The combustor nozzle as in claim 31, wherein the plurality of second fuel outlets are angled between approximately 20-80 degrees with respect to an axial centerline.

37. The combustor nozzle as in claim 31, wherein the oxidant outlet is angled between approximately 20-80 degrees with respect to an axial, centerline.

38. A method for supplying fuel to a combustor comprising:
a. flowing fuel through a fuel outlet;
b. flowing an oxidant through an oxidant outlet radially displaced from the fuel outlet; and
c. flowing a diluent through a diluent outlet radially outward of the fuel and oxidant outlets.

39. The method as in claim 38, further comprising flowing fuel through the fuel outlet so that the momentum of fuel flowing through the fuel outlet is less than approximately 50% of the momentum of the oxidant flowing through the oxidant outlet.

40. The method as in claim 38, further comprising swirling at least one of the fuel or oxidant.
